(19) United States
(12) Patent Application Publication
(10) Pub. No.: US 2006/0038951 A1
(43) Pub. Date: Feb. 23, 2006

(54) Liquid crystal display device with a pretilt angle of liquid crystal molecules

(75) Inventors: Chiu-Lien Yang, Miao-Li (TW); Wei-Yi Ling, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/206,691

(22) Filed: Aug. 18, 2005

(30) Foreign Application Priority Data
Aug. 23, 2004 (TW) 93125427

(51) Int. Cl. G02F 1/141

(52) U.S. Cl. 349/136

(57) ABSTRACT

An LCD device (10) includes a first substrate (22), a second substrate (21), and a liquid crystal layer (23) having liquid crystal molecules interposed between the first and second substrates. A pretilt angle of liquid crystal molecules is in the range from 0° to 15°. A first upper retardation film (521) is disposed at an outer surface of the first substrate. Preferably, the first upper retardation film is a quarter-wave plate. A first lower retardation film (511) is disposed at an outer surface of the second substrate. Preferably, the first lower retardation film is a quarter-wave plate. This helps ensure that the LCD device provides a good quality display. In addition, the alignment and the pretilt angle of the liquid crystal molecules in the liquid crystal layer are such that the liquid crystal molecules are homogeneously aligned when this is needed, and can be twisted in a very short time.

### FIELD OF THE INVENTION

The present invention relates to liquid crystal display (LCD) devices, and more particularly to a reflection/transmission type LCD device capable of providing a display both in a reflection mode and a transmission mode.

### GENERAL BACKGROUND

Conventionally, there have been three types of LCD devices commercially available: a reflection type LCD device utilizing ambient light, a transmission type LCD device utilizing backlight, and a semi-transmission type LCD device equipped with a half mirror and a backlight.

With a reflection type LCD device, a display becomes less visible in a dim environment. In contrast, with a transmission type LCD device, a display becomes hazy in strong ambient light (e.g., outdoor sunlight). Thus researchers sought to provide an LCD device capable of functioning in both modes so as to yield a satisfactory display in any environment. In due course, a semi-transmission type LCD device was disclosed in Japanese Laid-Open Publication No. 7-333598.

However, the above-mentioned conventional semi-transmission type LCD device has the following problems.

The conventional semi-transmission type LCD device uses a half mirror in place of a reflective plate used in a reflection type LCD device, and has a minute transmission region (e.g., minute holes in a metal thin film) in a reflection region, thereby providing a display by utilizing transmitted light as well as reflected light. Since reflected light and transmitted light used for a display pass through the same liquid crystal layer, an optical path of reflected light is twice as long as that of transmitted light. This causes a large difference in retardation of the liquid crystal layer with respect to reflected light and transmitted light. Thus, a satisfactory display cannot be obtained. Furthermore, a display in a reflection mode and a display in a transmission mode are superimposed on each other, so that the respective displays cannot be separately optimized. This results in difficulty in providing a color display, and tends to cause a blurred display.

What is needed, therefore, is a liquid crystal display device that overcomes the above-described deficiencies.

### SUMMARY

In a preferred embodiment, a liquid crystal display device includes a first substrate and a second substrate. A liquid crystal layer having liquid crystal molecules is interposed between the first and second substrates, with a pretilt angle of liquid crystal molecules in the liquid crystal layer being in the range from 0° to 15°. A first upper retardation film is disposed at an outer surface of the first substrate. Preferably, the first upper retardation film is a quarter-wave plate. A common electrode is disposed at an inner surface of the first substrate, and a pixel electrode is disposed at an inner surface of the second substrate. A plurality of pixel regions is defined, each of which includes a reflection region and a transmission region. A first lower retardation film is disposed at an outer surface of the first substrate. Preferably, the first lower retardation film is a quarter-wave plate.

According to other preferred embodiments, the liquid crystal display device may further include any one or combination of a first compensation film disposed between the first upper retardation film and the first substrate, a second compensation film disposed between the first lower retardation film and the second substrate, a first discotic molecular film disposed between the first upper retardation film and the first substrate, and a second discotic molecular film disposed between the first lower retardation film and the second substrate.

In certain of various embodiments of the LCD device, the retardation films and compensation films compensate for color in the reflection region and the transmission region of each of the pixel regions, in order to improve the characteristics of contrast and view angle. This helps ensure that the LCD device provides a good quality display. In addition, the alignment and the pretilt angle of the liquid crystal molecules in the liquid crystal layer are such that the liquid crystal molecules are homogeneously aligned and can be twisted in a very short time.

Other advantages and novel features will become more apparent from the following detailed description when taken in conjunction with the accompanying drawings.

### BRIEF DESCRIPTION OF THE DRAWINGS

FIG. 1 is a schematic, exploded, side cross-sectional view of part of an LCD device according to a first embodiment of the present invention.

FIG. 2 shows a polarized state of light in each of certain layers of the LCD device of FIG. 1, in respect of an on-state (white state) and an off-state (black state) of the LCD device, when the LCD device operates in a reflection mode.

FIG. 3 shows a polarized state of light in each of certain layers of the LCD device of FIG. 1, in respect of an on-state (white state) and an off-state (black state) of the LCD device, when the LCD device operates in a transmission mode.

FIG. 4 is a schematic, exploded, side cross-sectional view of part of an LCD device according to a second embodiment of the present invention.

FIG. 5 is a schematic, exploded, side cross-sectional view of part of an LCD device according to a third embodiment of the present invention.

FIG. 6 is a schematic, exploded, side cross-sectional view of part of an LCD device according to a fourth embodiment of the present invention.

FIG. 7 is a schematic, exploded, side cross-sectional view of part of an LCD device according to a fifth embodiment of the present invention.

FIG. 8 is a schematic, exploded, side cross-sectional view of part of an LCD device according to a sixth embodiment of the present invention.

FIG. 9 is a schematic, exploded, side cross-sectional view of part of an LCD device according to a seventh embodiment of the present invention.

FIG. 10 is a schematic, exploded, side cross-sectional view of part of an LCD device according to an eighth embodiment of the present invention.

FIG. 11 is a schematic, exploded, side cross-sectional view of part of an LCD device according to a ninth embodiment of the present invention.

### DETAILED DESCRIPTION OF PREFERRED EMBODIMENTS

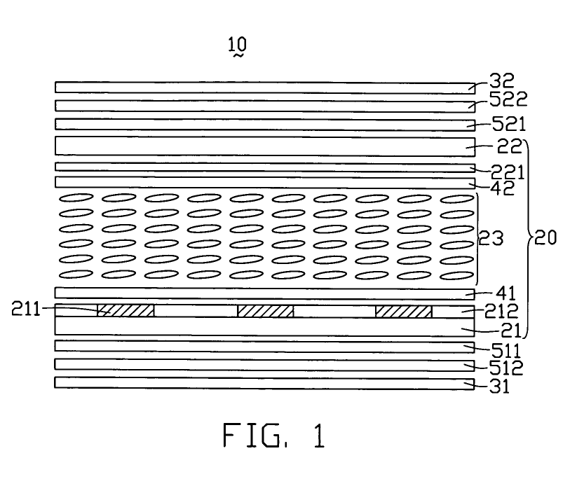

FIG. 1 is a schematic, exploded, side cross-sectional view of part of an LCD device 10 according to a first embodiment of the present invention. The LCD device 10 includes a first substrate 22, a second substrate 21 disposed parallel to and spaced apart from the first substrate 22, and a liquid crystal layer 23 having liquid crystal molecules (not labeled) sandwiched between the substrates 22 and 21. A pretilt angle of liquid crystal molecules in the liquid crystal layer 23 is in the range from 0° to 15°. The liquid crystal layer 23 is mixed with chiral dopant (not labeled), for easy orienting of the liquid crystal molecules.

A first upper retardation film 521, a second upper retardation film 522, and an upper polarizer 32 are orderly disposed on an outer surface of the first substrate 22. A first lower retardation film 511, a second lower retardation film 512, and a lower polarizer 31 are orderly disposed on an outer surface of the second substrate 21. The upper and lower polarizers 32, 31 are rubbed to achieve an original alignment angle. Each of original alignment angle of the upper and lower polarizers 32, 31 is in the range from 0° to 90°.

A transparent common electrode 221 and an upper alignment film 42 are orderly disposed on an inner surface of the first substrate 22. The common electrode 221 is made of a transparent conductive material, such as indium-tin-oxide (ITO) or indium-zinc-oxide (IZO).

A plurality of transmission electrodes 212 and a plurality of reflection electrodes 211 are disposed on an inner surface of the second substrate 21. The transmission electrodes 212 are made of a transparent conductive material, such as indium-tin-oxide (ITO) or indium-zinc-oxide (IZO). The reflection electrodes 211 are made of metal with a high reflective ratio, such as aluminum (Al). A lower alignment film 41 is disposed on the transmission and reflection electrodes 212, 211.

The first substrate 22, the transparent common electrode 221, the upper alignment film 42, the liquid crystal layer 23, the lower alignment film 41, the transmission and reflection electrodes 212, 211, and the second substrate 21 are collectively referred to hereinbelow as a liquid crystal panel 20.

The liquid crystal layer 23, the common electrode 221, the transmission electrodes 212 and the reflection electrodes 211 cooperatively define a plurality of pixel regions. Each pixel region includes a reflection region corresponding to a respective reflection electrode 211, and a transmission region corresponding to a respective transmission electrode 212. The thickness of the liquid crystal layer 23 in the reflection regions and the transmission regions is the same. When a voltage is applied to the LCD device 10, an electric field is generated between the common electrode 221, the transmission electrodes 212 and the reflection electrodes 211. The electric field can control the liquid crystal molecules to orient for displaying images.

The first upper and lower retardation films 521 and 511 are quarter-wave plates. The second upper and lower retardation films 522 and 512 are half-wave plates. The upper polarizer 32 has a polarizing axis perpendicular to a polarizing axis of the lower polarizer 31, and the first upper retardation film 521 has an optical axis perpendicular to an optical axis of the first lower retardation film 511.

The optical axis of the second upper retardation film 522 maintains an angle θ₁ relative to the polarizing axis of the upper polarizer 32, and the optical axis of the first upper retardation film 521 maintains an angle of 2θ₁±45° relative to the polarizing axis of the upper polarizer 32. The angle θ₁ is in the range from 8° to 22° or in the range from 68° to 82°. The optical axis of the second lower retardation film 512 maintains an angle θ₂ relative to the polarizing axis of the lower polarizer 31, and the optical axis of the first lower retardation film 511 maintains an angle of 2θ₂±45° relative to the polarizing axis of the lower polarizer 31. The angle θ₂ is in the range from 8° to 22° or in the range from 68° to 82°.

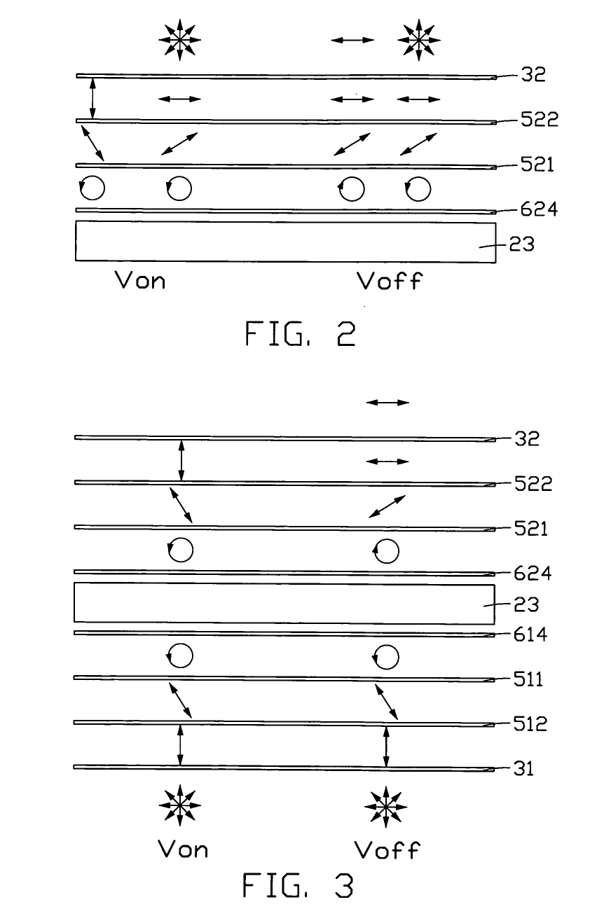

FIG. 2 shows a polarized state of light in each of certain layers of the LCD device 10, in respect of an on-state (white state) and an off-state (black state) of the LCD device 10, when the LCD device 10 operates in a reflection mode. As shown, the LCD device 10 further comprises an upper compensation film 624 between the first upper retardation film 521 and the liquid crystal layer 23, and a lower compensation film 614 between the liquid crystal layer 23 and the first lower retardation film 511. When no voltage is applied to the LCD device 10, the LCD device 10 is in an on-state. The linearly-polarized light passes through the second upper retardation film 522 (a half-wave plate). The polarized state of the linearly-polarized light is not changed, and the polarizing direction thereof twists by an amount of 20. Thereafter, the linear-polarized light is incident upon the first upper retardation film 521 (a quarter-wave plate), and becomes circularly-polarized light. Then the circularly-polarized light passes through the upper compensation film 624 and is incident on the liquid crystal layer 23. Since an effective phase difference of the liquid crystal layer 23 in an on-state is adjusted to a wavelength of λ/4 in order to obtain a white display, the incident circularly-polarized light becomes linearly-polarized light. The linearly-polarized light exiting the liquid crystal layer 23 is reflected by the reflection electrodes 211. The linearly-polarized light keeps its polarized state, and is incident on the liquid crystal layer 23 again. The linearly-polarized light passing through the liquid crystal layer 23 becomes circularly-polarized light having a polarizing direction opposite to that of the circularly-polarized light originally incident on the liquid crystal layer 23. The circularly-polarized light exiting the liquid crystal layer 23 is converted to linearly-polarized light by the quarter-wave plate 521. Thereafter, the linearly-polarized light passes through the half-wave plate 522, and is output through the upper polarizer 32 for displaying images.

On the other hand, when a voltage is applied to the LCD device 10, the LCD device 10 is in an off-state. Up to the point where ambient incident light reaches the liquid crystal layer 23, the ambient incident light undergoes transmission in substantially the same way as described above in relation to the LCD device 10 being in the on-state. Since an effective phase difference of the liquid crystal layer 23 is adjusted to be 0 by applying a voltage in order to obtain a black display, the circularly-polarized light incident on the liquid crystal layer 23 passes therethrough as circularly-polarized light. The circularly-polarized light exiting the liquid crystal layer 23 is reflected by the reflection electrodes 211. The circularly-polarized light keeps its polarized state, and is incident on the liquid crystal layer 23 again. After passing through the liquid crystal layer 23, the circularly-polarized light is converted into linearly-polarized light by the first upper retardation film 521 (a quarter-wave plate). At this time, the polarizing direction of the linearly-polarized light is rotated by about 90° compared with that of a white display state. Thus the linearly-polarized light is not output from the LCD device 10 for displaying images.

FIG. 3 shows a polarized state of light in each of certain layers of the LCD device 10, in respect of an on-state (white state) and an off-state (black state) of the LCD device 10, when the LCD device 10 operates in a transmission mode. Incident light undergoes transmission in a manner similar to that described above in relation to the LCD device 10 operating in the reflection mode. However, circularly-polarized light passes through the lower compensation film 614 before it is incident on the liquid crystal layer 23. The lower compensation film 614 functions in like manner to the upper compensation film 624.

In each pixel region of the LCD device 10, the liquid crystal molecules have a pre-tilt angle, which ensures that the liquid crystal molecules can more easily twist when a voltage is applied thereto. Thereby, the LCD device 10 has a fast response time. Moreover, the retardation films and compensation films are used for compensating for color, so as to ensure that the LCD device 10 has a good quality display.

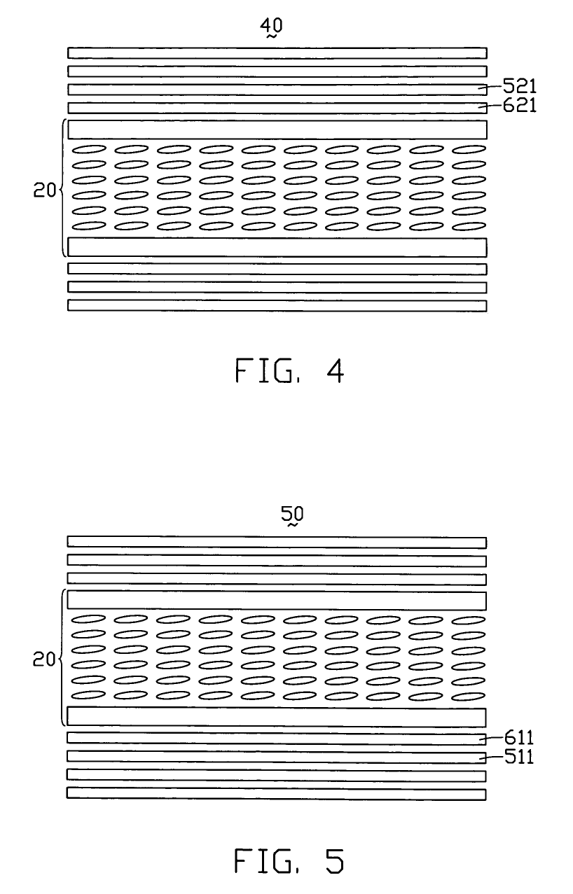

FIG. 4 is a schematic, exploded, side cross-sectional view of part of an LCD device 40 according to a second embodiment of the present invention. The LCD device 40 is similar to the LCD device 10 of FIG. 1. However, the LCD device 40 includes a discotic molecular film 621 disposed between the first upper retardation film 521 and the liquid crystal panel 20.

FIG. 5 is a schematic, exploded, side cross-sectional view of part of an LCD device 50 according to a third embodiment of the present invention. The LCD device 50 is similar to the LCD device 10 of FIG. 1. However, the LCD device 50 includes a discotic molecular film 611 disposed between the first lower retardation film 511 and the liquid crystal panel 20.

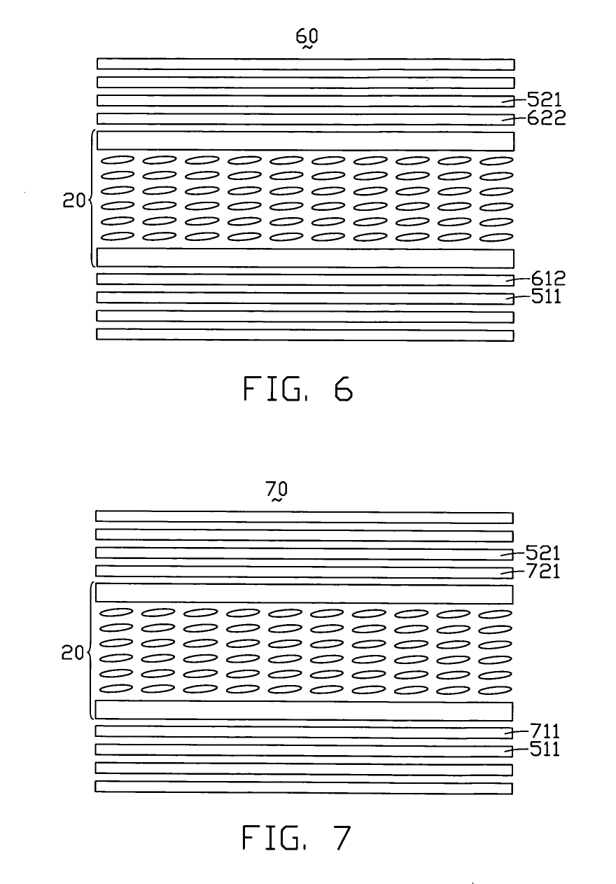

FIG. 6 is a schematic, exploded, side cross-sectional view of part of an LCD device 60 according to a fourth embodiment of the present invention. The LCD device 60 is similar to the LCD device 10 of FIG. 1. However, the liquid crystal display 60 includes a first discotic molecular film 622 disposed between the first upper retardation film 521 and the liquid crystal panel 20, and a second discotic molecular film 612 disposed between the first lower retardation film 511 and the liquid crystal panel 20.

FIG. 7 is a schematic, exploded, side cross-sectional view of part of an LCD device 70 according to a fifth embodiment of the present invention. The LCD device 70 is similar to the LCD device 10 of FIG. 1. However, the LCD device 70 includes a first compensation film 721 disposed between the first upper retardation film 521 and the liquid crystal panel 20, and a second compensation film 711 disposed between the first lower retardation film 511 and the liquid crystal panel 20. Preferably, the first compensation film 721 and the second compensation film 711 are A-plate compensation films. That is, the first and second compensation films 721, 711 are different from the upper and lower compensation films 624, 614.

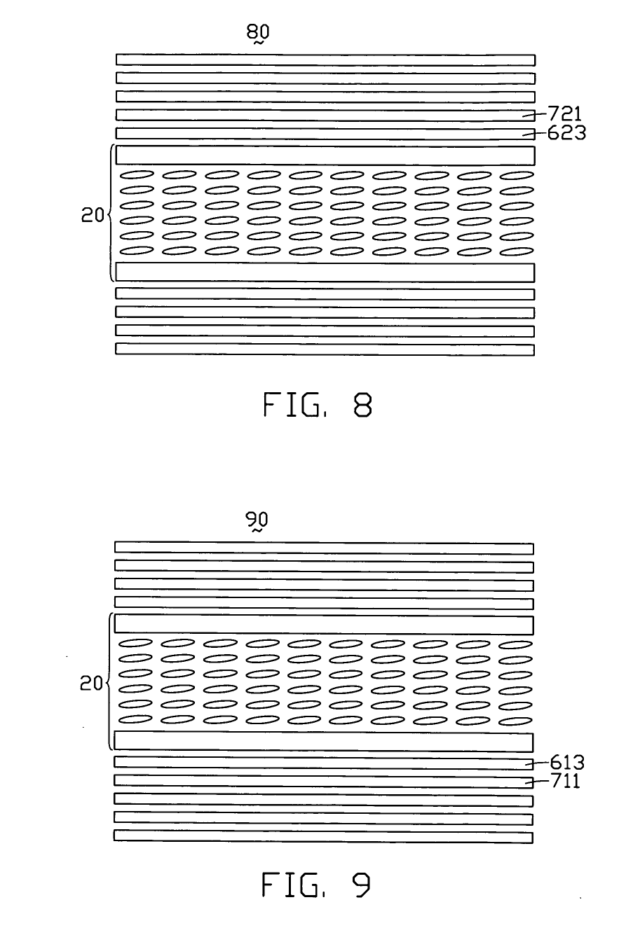

FIG. 8 is a schematic, exploded, side cross-sectional view of part of an LCD device 80 according to a sixth embodiment of the present invention. The LCD device 80 is similar to the LCD device 70 of FIG. 7. However, the LCD device 80 includes a discotic molecular film 623 disposed between the first compensation film 721 and the liquid crystal panel 20.

FIG. 9 is a schematic, exploded, side cross-sectional view of part of an LCD device 90 according to a seventh embodiment of the present invention. The LCD device 90 is similar to the LCD device 70 of FIG. 7. However, the LCD device 90 includes a discotic molecular film 613 disposed between the second compensation film 711 and the liquid crystal panel 20.

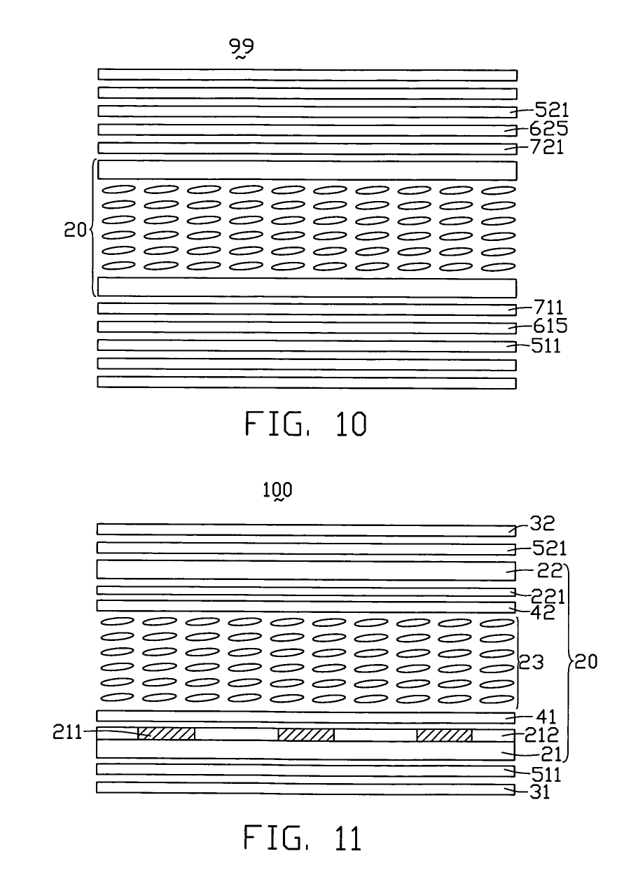

FIG. 10 is a schematic, exploded, side cross-sectional view of part of an LCD device 99 according to an eighth embodiment of the present invention. The LCD device 99 is similar to the LCD device 70 of FIG. 7. However, the LCD device 99 includes a first discotic molecular film 625 disposed between the first upper compensation film 721 and the first upper retardation film 521, and a second discotic molecular film 615 disposed between the first lower compensation film 711 and the first lower retardation film 511.

In relevant of the above-described LCD devices, the retardation films 521, 522, 511, 512 and the compensation films 614, 624, 711, 721 can compensate for color in the reflection region and the transmission region of each of the pixel regions to improve the characteristics of contrast and viewing angle. This helps ensure that the LCD device provides a good quality display. In addition, the alignment and the pretilt angle of the liquid crystal molecules in the liquid crystal layer are such that the liquid crystal molecules are homogeneously aligned and can be twisted in a very short time.

FIG. 11 is a schematic, exploded, side cross-sectional view of part of an LCD device 100 according to a ninth embodiment of the present invention. The LCD device 100 is similar to the LCD devices of FIG. 1 through FIG. 10. The difference between the LCD device 100 and the LCD devices of FIG. 1 through FIG. 10 is that in the LCD device 100, the second upper and lower retardation films 522 and 512 are omitted.

Various modifications and alterations are possible within the ambit of the invention herein. For example, the compensation films may be biaxial compensation films, single compensation films, A-plate compensation films, or discotic molecular films. In addition, the LCD device may employ only a single compensation film disposed on either the first substrate or on the second substrate. Furthermore, any or all of the retardation films and compensation films may be disposed on or at inner surfaces of either of the first and second substrates.

It is to be understood, however, that even though numerous characteristics and advantages of the present embodiments have been set out in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A liquid crystal display device, comprising:
a first substrate and a second substrate;
a liquid crystal layer having liquid crystal molecules interposed between the first and second substrates, with a pretilt angle of the liquid crystal molecules being in the range from 0° to 15°;
a first upper retardation film disposed at an outer surface of the first substrate, the first upper retardation film being a quarter-wave plate;
a common electrode disposed at an inner surface of the first substrate;
a pixel electrode disposed at an inner surface of the second substrate;
a plurality of pixel regions, each of the pixel regions including a reflection region and a transmission region; and
a first lower retardation film disposed at an outer surface of the first substrate, the first lower retardation film being a quarter-wave plate.

2. The liquid crystal display device as claimed in claim 1, wherein the liquid crystal layer further has chiral dopant mixed therein.

3. The liquid crystal display device as claimed in claim 1, wherein a first polarizer is provided at the first substrate, and a second polarizer is provided under the second substrate, and the polarizers are rubbed to achieve an original alignment angle, each of the first polarizer and the second polarizer is in the range from 0° to 90°.

4. The liquid crystal display device as claimed in claim 3, wherein the reflection region includes a reflective electrode, and the reflective electrode is made of metallic material with a high reflectivity.

5. The liquid crystal display device as claimed in claim 3, wherein the first polarizer has a polarizing axis perpendicular to a polarizing axis of the second polarizer, and the first upper retardation film has an optical axis perpendicular to an optical axis of the first lower retardation film.

6. The liquid crystal display device as claimed in claim 1, further comprising a first discotic molecular film disposed between the first upper retardation film and the first substrate.

7. The liquid crystal display device as claimed in claim 1, further comprising a second discotic molecular film disposed between the first lower retardation film and the second substrate.

8. The liquid crystal display device as claimed in claim 1, further comprising a first compensation film disposed between the first upper retardation film and the first substrate, and a second compensation film disposed between the first lower retardation film and the second substrate.

9. The liquid crystal display device as claimed in claim 8, wherein each of the first compensation film and the second compensation film is an A-plate compensation film.

10. A liquid crystal display device, comprising:
a first substrate and a second substrate;
a liquid crystal layer having liquid crystal molecules interposed between the first and second substrates, a pretilt angle of the liquid crystal molecules being in the range about 0° to 15°;
a first upper retardation film and a second upper retardation film disposed at an outer surface of the first substrate;
a common electrode disposed at an inner surface of the first substrate;
a pixel electrode disposed at an inner surface of the second substrate;
a plurality of pixel regions, each of the pixel regions including a reflection region and a transmission region; and
a first lower retardation film and a second lower retardation film disposed at an outer surface of the second substrate.

11. The liquid crystal display device as claimed in claim 10, wherein the first upper retardation film is a quarter-wave plate, and the second upper retardation film is a half-wave plate.

12. The liquid crystal display device as claimed in claim 10, wherein the first lower retardation film is a quarter-wave plate, and the second lower retardation film is a half-wave plate.

13. The liquid crystal display device as claimed in claim 10, wherein a first polarizer is provided at the first substrate, a second polarizer is provided under the second substrate, and an original alignment angle of each of the first polarizer and the second polarizer is in the range from 0° to 90°.

14. The liquid crystal display device as claimed in claim 13, wherein an optical axis of the second upper retardation film maintains an angle θ₁ relative to a polarizing axis of the first polarizer, and an optical axis of the first upper retardation film maintains an angle of 2θ₁±45° relative to the polarizing axis of the first polarizer.

15. The liquid crystal display device as claimed in claim 14, wherein θ₁ is in the range from 8° to 22° or in the range from 68° to 82°.

16. The liquid crystal display device as claimed in claim 13, wherein the optical axis of the second lower retardation film maintains an angle θ₂ relative to a polarizing axis of the second polarizer, and an optical axis of the first lower retardation film maintains an angle of 2θ₂±45° relative to the polarizing axis of the second polarizer.

17. The liquid crystal display device as claimed in claim 16, wherein θ₂ is in the range from 8° to 22° or in the range from 68° to 82°.

18. The liquid crystal display device as claimed in claim 10, further comprising a discotic molecular film disposed between the first upper retardation film and the first substrate.

19. The liquid crystal display device as claimed in claim 10, further comprising a discotic molecular film disposed between the first lower retardation film and the second substrate.

20. The liquid crystal display device as claimed in claim 10, further comprising a first compensation film disposed between the first upper retardation film and the first substrate, and a second compensation film disposed between the first lower retardation film and the second substrate.
